(19) United States
(12) Patent Application Publication
(10) Pub. No.: US 2025/0305580 A1
(43) Pub. Date: Oct. 2, 2025

(54) SOLENOID DRIVEN LOCKING MECHANISM FOR ELECTROMECHANICAL ACTUATOR ASSEMBLIES

(71) Applicant: B/E Aerospace, Inc., Winston-Salem, NC (US)

(72) Inventors: Pradeep Acharya, Bangalore (IN); Stephen H. Davies, Shrewsbury (GB); Sreekanth Rao, Bangalore (IN)

(21) Appl. No.: 19/089,682

(22) Filed: Mar. 25, 2025

(30) Foreign Application Priority Data
Apr. 1, 2024 (IN) 202441027086

(51) Int. Cl. F16H 63/30

(52) U.S. Cl. CPC F16H 63/304; F16H 2063/305

(57) ABSTRACT

A lock mechanism for an electromechanical actuator assembly, the lock mechanism including a housing, a solenoid mounted to the housing and including a reciprocating shaft, a rotor gear mounted on the reciprocating shaft and including locking ribs positioned on a face of the rotor gear, a spring-loaded plunger body coupled to one end of the reciprocating shaft, and spring-loaded lock pins carried by the plunger body. In use, energizing the solenoid causes the reciprocating shaft to push the spring-loaded plunger body away from the rotor gear thereby moving the lock pins out of contact with the locking ribs to permit rotation of the rotor gear.

### CROSS REFERNCE TO RELATED APPLICATION

This application claims the benefit of priority of Indian Patent Application No. 202441027086 filed Apr. 1, 2024, which is hereby incorporated by reference in its entirety.

### TECHNICAL FIELD AND BACKGROUND

The present disclosure relates generally to a mechanism for locking rotation, and more particularly, to a solenoid driven lock mechanism operable as a braking mechanism for electromechanical actuator assemblies.

Rotary actuators are used to drive component motions. In aircraft, for example, rotary actuators may be used to drive seat support component motions to change sitting positions. While traditional actuators provide the necessary braking torque to ensure the stoppage of movement, stepper motors are typically utilized with actuators as a failsafe braking mechanism. Stepper motors are disadvantageous in that they are large, operate continuously, draw power, generate heat, increase system complexity, and are prone to failure.

Accordingly, what is needed is a failsafe braking mechanism that overcomes the disadvantages of traditional stepper motors.

### BRIEF SUMMARY

According to one aspect, the inventive concepts according to the present disclosure are directed to a lock mechanism for an electromechanical actuator assembly. In embodiments, the lock mechanism includes a housing mountable to an electromechanical actuator assembly, a solenoid mounted to the housing and including a reciprocating shaft, a rotor gear mounted on the reciprocating shaft and including at least one locking rib positioned on a face of the rotor gear, a spring-loaded plunger body coupled to one end of the reciprocating shaft, and at least one spring-loaded lock pin carried by the plunger body. In use, when the solenoid is de-energized, spring force pushes the spring-loaded plunger body toward the rotor gear and spring force pushes the at least one spring-loaded lock pin into contact with the at least one locking rib to prevent rotation of the rotor gear. In use, when the solenoid is energized, the reciprocating shaft pushes the spring-loaded plunger body away from the rotor gear thereby moving the at least one spring-loaded lock pin out of contact with the at least one locking rib to permit rotation of the rotor gear.

In some embodiments, the face of the rotor gear includes three equidistant and radially-extending locking ribs, the spring-loaded plunger body carries two independent spring-loaded lock pins, and when the solenoid is de-energized, the two independent spring-loaded lock pins contact two of the three equidistant and radially-extending locking ribs to prevent the rotor gear from rotating.

In some embodiments, the locking ribs extend in a direction of the plunger body.

In some embodiments, the lock mechanism further includes a connector gear rotatably mounted to the housing and meshed with the rotor gear, the connector gear configured to mesh with a gear of the electromechanical actuator assembly.

In some embodiments, the at least one spring-loaded lock pin is slidably disposed in the plunger body.

In some embodiments, the plunger body includes a first plate and a second plate spaced apart by a middle connecting portion, and the at least one spring-loaded lock pin includes a shoulder movably disposed between the first plate and the second plate.

According to another aspect, the inventive concepts according to the present disclosure are directed to an actuator assembly including an electromechanical actuator subassembly including a first housing, a motor mounted to the first housing, at least one gearbox mounted in the first housing, and a shaft rotatably by the at least one gearbox. The actuator assembly further includes a lock mechanism including a second housing mounted to the first housing, a solenoid mounted to the second housing and including a reciprocating shaft, a rotor gear mounted on the reciprocating shaft and including at least one locking rib positioned on one face of the rotor gear, a connector gear meshed with the rotor gear and the at least one gearbox, a spring-loaded plunger body coupled to one end of the reciprocating shaft, and at least one spring-loaded lock pin carried by the plunger body. In use, when the solenoid is de-energized, spring force pushes the spring-loaded plunger body toward the rotor gear and spring force pushes the at least one spring-loaded lock pin into contact with the at least one locking rib to prevent rotation of the rotor gear thereby preventing the at least one gearbox and the shaft of the electromechanical actuator subassembly from rotating. In use, when the solenoid is energized, the reciprocating shaft pushes the spring-loaded plunger body away from the rotor gear thereby moving the at least one spring-loaded lock pin out of contact with the at least one locking rib to permit rotation of the rotor gear thereby permitting the at least one gearbox and the shaft of the electromechanical actuator subassembly to rotate.

According to a further aspect, the inventive concepts according to the present disclosure are directed to a method for controlling rotation of a shaft of an electromechanical actuator assembly. In embodiments, the method includes providing a lock mechanism according to the above, mounting the lock mechanism to an electromechanical actuator assembly such that the connector gear is meshed with a gearbox for rotating the shaft, de-energizing the solenoid such that spring force pushes the spring-loaded plunger body toward the rotor gear and spring force pushes the at least one spring-loaded lock pin into contact with the at least one locking rib to prevent rotation of the rotor gear and locking rotation of the shaft of the electromechanical actuator assembly, and energizing the solenoid such that the reciprocating shaft pushes the spring-loaded plunger body away from the rotor gear thereby moving the at least one spring-loaded lock pin out of contact with the at least one locking rib to permit rotation of the rotor gear to unlock rotation of the shaft of the electromechanical actuator subassembly.

This summary is provided solely as an introduction to subject matter that is fully described in the following detailed description and drawing figures. This summary should not be considered to describe essential features nor be used to determine the scope of the claims. Moreover, it is to be understood that both the foregoing summary and the following detailed description are explanatory only and are not necessarily restrictive of the subject matter claimed.

### BRIEF DESCRIPTION OF THE DRAWINGS

Implementations of the inventive concepts disclosed herein may be better understood when consideration is given to the following detailed description thereof. Such description refers to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 is a perspective view of an electromechanical actuator assembly including a lock mechanism, in accordance with example embodiments of this disclosure;

FIG. 2 is a cutaway view illustrating the components of the electromechanical actuator assembly shown in FIG. 1, in accordance with example embodiments of this disclosure;

FIG. 3 illustrates the lock mechanism, in accordance with example embodiments of this disclosure;

FIG. 4 is an isometric view illustrating the assembly sequence of the lock mechanism to the actuator housing, in accordance with example embodiments of this disclosure;

FIG. 5 is a schematic illustration of the positional relationship between the lock pins and the locking ribs, in accordance with example embodiments of this disclosure;

FIG. 6A is an isometric view of the lock mechanism, in accordance with example embodiments of this disclosure;

FIG. 6B is a detailed view of the rotor gear of the lock mechanism, in accordance with example embodiments of this disclosure;

FIG. 7A is a fragmentary sectional view showing the lock mechanism in an energized state, in accordance with example embodiments of this disclosure;

FIG. 7B is a flowchart showing the working sequence of the energized lock mechanism, in accordance with example embodiments of this disclosure;

FIG. 8A is a fragmentary sectional view showing the lock mechanism in a de-energized state, in accordance with example embodiments of this disclosure; and

FIG. 8B is a flowchart showing the working sequence of the de-energized lock mechanism, in accordance with example embodiments of this disclosure.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein, a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein are directed to a modular, solenoid-based, failsafe lock mechanism for use with electromechanical actuator assemblies. In embodiments, the lock mechanism is by default mechanically active, and is energized to ‘unlock’ the mechanism (i.e., release the brake via solenoid energization). In embodiments, the solenoid power requirement is about 5 W. Benefits of the lock mechanism include, but are not limited to, reliable architecture, failsafe mechanism cost and weight reduction, comparatively low power consumption, and 100% duty cycle.

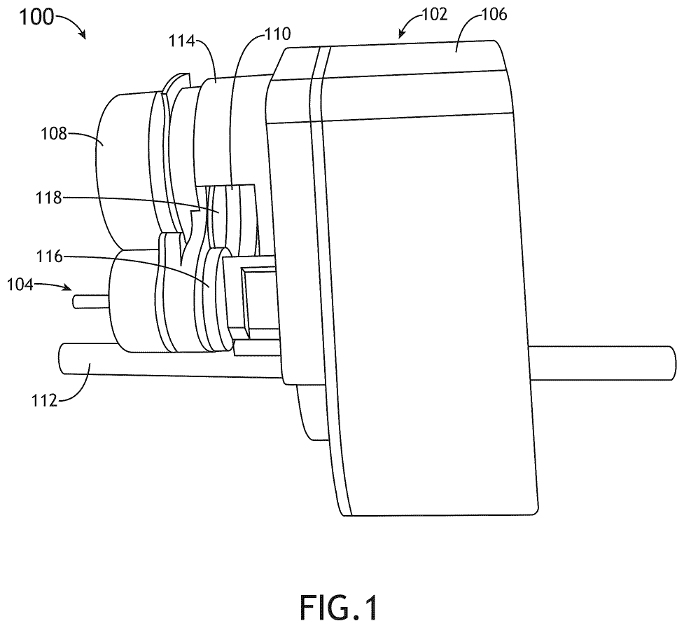

FIG. 1 illustrates an actuator assembly 100 according to the present disclosure. The actuator assembly 100 may be used to control a movable component, for instance a support component associated with a passenger seat (e.g., backrest, seat bottom, legrest, etc.). The actuator assembly 100 generally includes an electromechanical actuator subassembly 102 and a solenoid-based lock mechanism 104, hereafter referred to as the “lock mechanism.” The electromechanical actuator subassembly 102 generally includes a housing 106, a motor 108 mounted to the housing 106, at least one gearbox 110 mounted in the housing 106, and a shaft 112 coupled to the at least one gearbox 110. The at least one gearbox 110 is operative to rotate the shaft 112 when the motor 108 is energized. The particular configuration of the at least one gearbox 110 and the shaft 112 is not critical and may vary. As shown, the motor 108 is mounted to a cylindrical extension 114 of the housing 106, and a portion of the cylindrical extension is open to expose a portion of the at least one gearbox 110 contained therein.

In the particular conceived example shown, the lock mechanism 104 is mounted to the housing 106 such that a rotor gear 116 of the lock mechanism 104 is rotatably coupled to the at least one gearbox 110 through an intermediate connector gear 118. In use, the motor 108 is energized to cause the at least one gearbox 110 to operate to rotate the shaft 112. In embodiments, the at least one gearbox 110 may include a plurality of gears configured to rotate synchronously. As the gears of the at least one gearbox 110 rotate, so does the intermediate connector gear 118 and also the rotor gear 116 meshed with the connector gear 118. Thus, when the electromechanical actuator assembly 102 is active and rotating, the gears 116, 118 of the lock mechanism 104 re also rotating. As discussed in detail below, when the lock mechanism 104 is energized, the rotor gear 116 rotation is stopped which thereby stops the rotation of the at least one gearbox 110 and consequently the shaft 112.

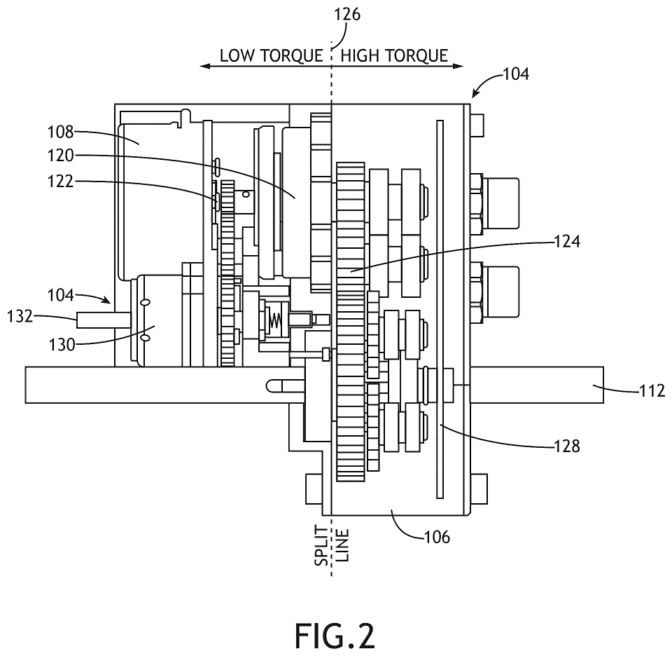

FIG. 2 illustrates the lock mechanism 104 in use with an electromechanical actuator subassembly 102 having a particular gearbox configuration. In a non-limiting example, the electromechanical actuator subassembly 102 includes an epicyclic gearbox 120 coupled to the motor shaft 122 of the motor 108 on a low torque side of the assembly 100, and a spur gearbox 124 coupled to the shaft 112 on a high torque side of the assembly 100. As shown, reference line 126 shows the demarcation between the low torque side on the left, and the high torque side on the right as shown in the drawing. A printed circuit board 128 operable for controlling the motor and solenoid-based lock mechanism 104 may be positioned in the housing 106.

For compact packaging, the solenoid 130 of the lock mechanism 104 may be mounted to the housing 106 alongside the motor 108 such that a reciprocating shaft 132 of the solenoid 126 is oriented parallel to the shaft 112. Gear types in the assembly 100 may include, but are not limited to, spur gears (e.g., hubbed or hubless), bevel gears, single gears, double gears, etc., each having cut teeth that are meshed with another toothed gear or component to transmit rotational power.

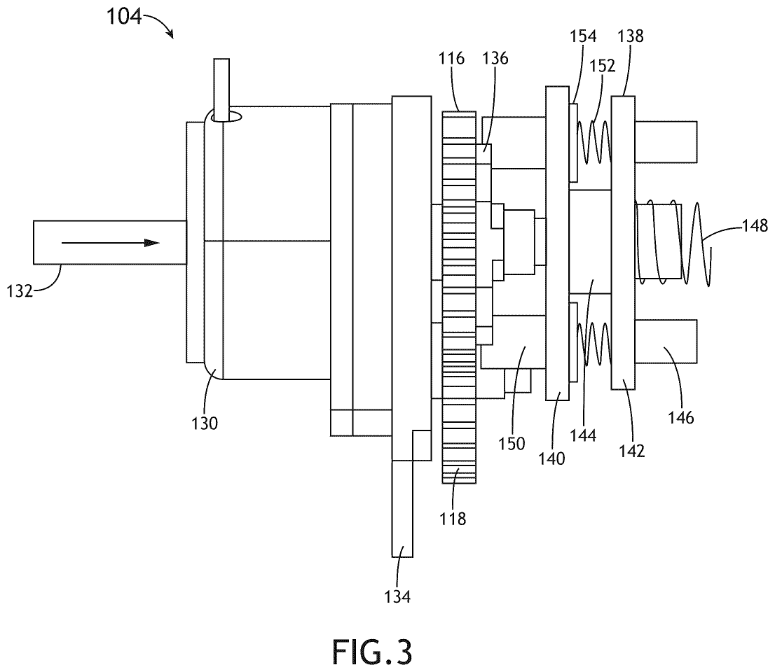

FIG. 3 illustrates a configuration of the lock mechanism 104. A housing 134 is configured to be mounted to the electromechanical actuator housing (106 in FIG. 1) to mount the lock mechanism 104 to the electromechanical actuator assembly (102 in FIG. 1). The solenoid 130 is mounted to the housing 134 such that the reciprocating shaft 132 extends through the housing 134. In embodiments, the solenoid 130 includes a coil configured to be energized to cause the reciprocating shaft 132 to translate to the right as shown in the drawing, and translate to the left as shown in the drawing when the solenoid 130 is de-energized as discussed in detail below. The solenoid 130 is therefore electrically coupled to a power source, and in embodiments is coupled to the printed circuit board (128 in FIG. 2).

The rotor gear 116 is mounted to the reciprocating shaft 132, and is meshed with the connector gear 118 in turn meshed to the at least one gearbox as discussed above. The rotor gear 116 includes circumferential cut teeth and opposing faces. The face of the rotor gear 116 facing away from the solenoid 130 carries at least one locking rib 136. The at least one locking rib 136 may be mounted to the face of the rotor gear 116 or may be an integrally formed part of the rotor gear 116.

With continued reference to FIG. 3, a spring-loaded plunger stop 138 is coupled to the end of the reciprocating shaft 132. In embodiments, the spring-loaded plunger stop 138 includes a first plate 140 and a second plate 142 connected by a middle connecting portion 144, for instance coaxial with the reciprocating shaft 132. In embodiments, the second plate 142 includes spaced posts 146 extending away from the solenoid 130 for being received in corresponding alignment openings formed in the housing of the electromechanical actuator assembly. The middle connecting portion 144 continues to the right of the second plate 142 and functions to seat a helical coil spring 148 for biasing the spring-loaded plunger stop 138 toward the rotor gear 116.

In use, when the solenoid 130 is de-energized, the spring force of the helical coil spring 148 pushes the spring-loaded plunger stop 138 toward the rotor gear 116 thereby locking rotation of the rotor gear 116 as discussed below. In use, when the solenoid 130 is energized, the reciprocating shaft 132 is driven toward the spring-loaded plunger stop 138 (i.e., to the right as shown in the drawing), thereby overcoming the spring force of the helical coil spring 148 and moving the spring-loaded plunger stop 138 to the right to allow the rotor gear 116 to rotate as discussed below.

The first plate 140 includes spaced openings each receiving a spring-loaded lock pin 150 slidably disposed in its respective opening. As shown, each lock pin 150 is biasing toward the rotor gear 116 by a helical coil spring 152 seated within the lock pin 150 and against the second plate 142. In embodiments, each lock pin 148 includes an annular should 154 movably positioned between the first and second plates 140, 142. As discussed below, each helical coil spring 152 biases its respective lock pin 150 toward the at least one locking rib 136 to ensure contact therewith. In use, when the solenoid 130 is energized and the spring-loaded plunger stop 138 is driven away from the rotor gear 116, the first plate 142 urges against the annular shoulders 154 to move the lock pins 150 out of contact with the at least one locking rib 136 to allow the rotor gear 116 to rotate.

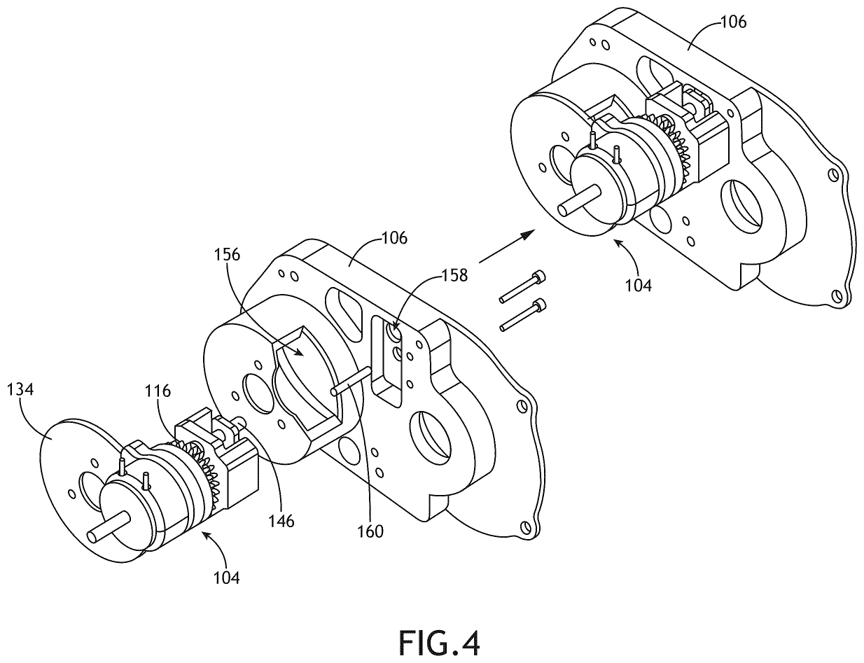

FIG. 4 illustrates the assembly sequence for mounting the lock mechanism 104 to the housing 106 of the electromechanical actuator assembly. As shown, the cylindrical extension of the housing 106 includes a cutaway 156 through which the connector gear, or in the absence of a connector gear the rotor gear, interfaces with a gear of the at least one gearbox within the electromechanical actuator assembly. The housing 134 of the lock mechanism 104 may be mounted to the end of the cylindrical extension such that the rotor gear 116 is positioned alongside the cylindrical extension for gear alignment. Also shown are the openings 158 formed in the housing 106 for receiving the posts 146 of the spring-loaded plunger stop 138 to constrain and maintain the orientation of the spring-loaded plunger stop 138. In some embodiments, the spring-loaded plunder stop 138 may mount on a stud 160 affixed to the housing 106.

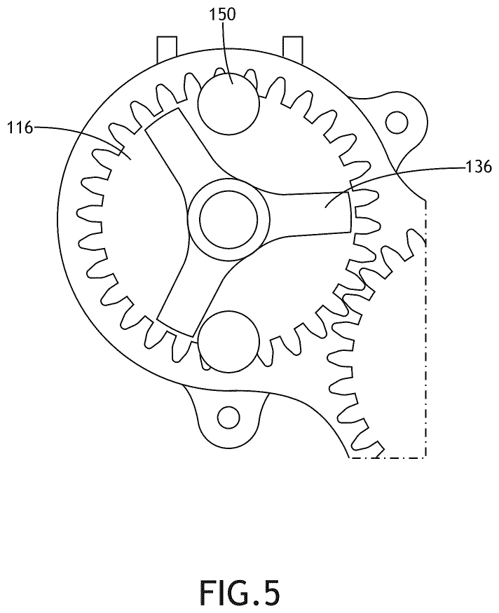

FIG. 5 illustrates the interface of the spring-loaded lock pins 150 and the locking ribs 136 for locking the rotation of the rotor gear 116. In embodiments, the locking ribs 136 include three equidistant-spaced and radially extending locking ribs 136 for interacting with two spaced and spring-loaded lock pins 150. Including three locking ribs 136 and two lock pins 150 in the arrangement shown ensures that at least one lock pin 150 is shear loaded to stop the rotor gear 116 from rotating. The equidistant spacing of the locking ribs 136 ensures that, regardless of the timing of the stoppage, at least one of the lock pins 150 will be positioned between adjacent locking ribs 136. In some instance, both lock pins 150 may be positioned in the spaced between adjacent locking ribs 136, and in other instances, one lock pin may be positioned in the space between adjacent locking ribs 136 while the other lock pin 150 is positioned against the ‘face’ of one of the locking ribs 136. Thus, shear loads are taken up by at least one of the independent spring-loaded lock pins 150 housed in the spring-loaded plunger body.

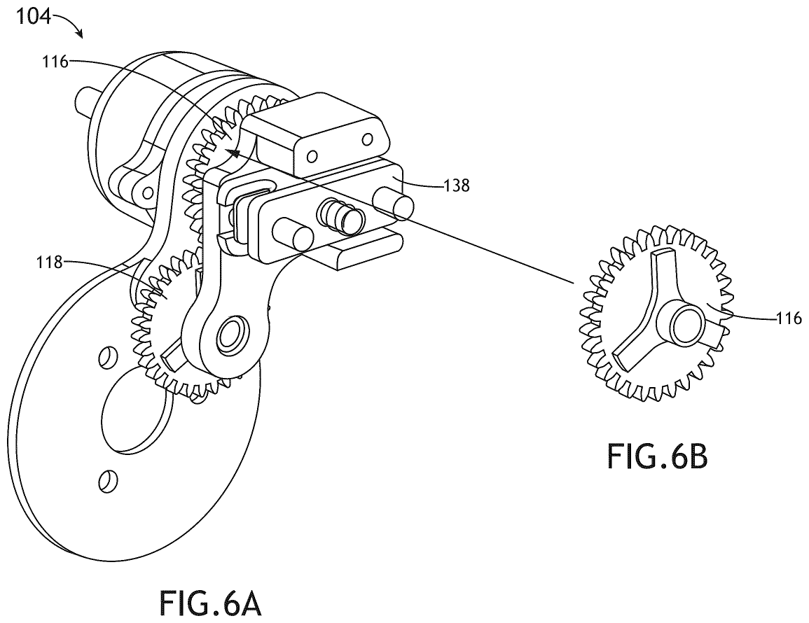

FIGS. 6A and 6B illustrate the respective lock mechanism 104 and the rotor gear 116, and further illustrate a second housing 160 for rotatably mounting the connector gear 118 and rotationally constraining the spring-loaded plunger body 138. In the configuration shown, the spring-loaded plunger body 138 is able to translate but is not able to rotate.

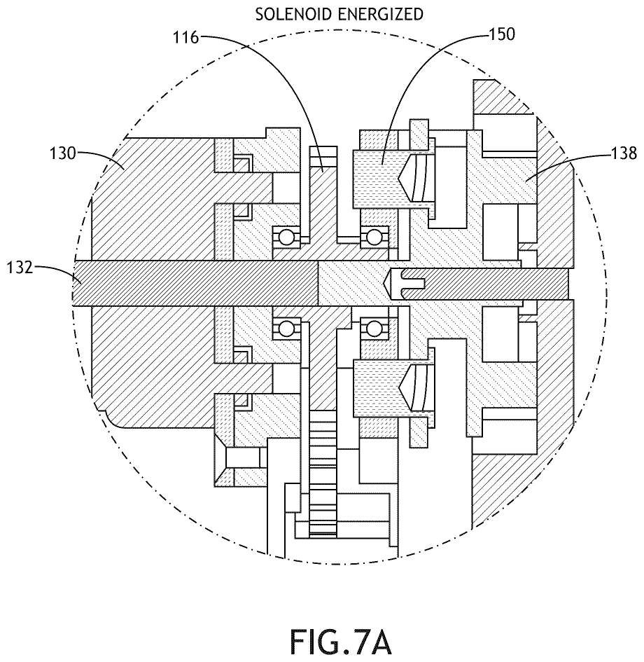

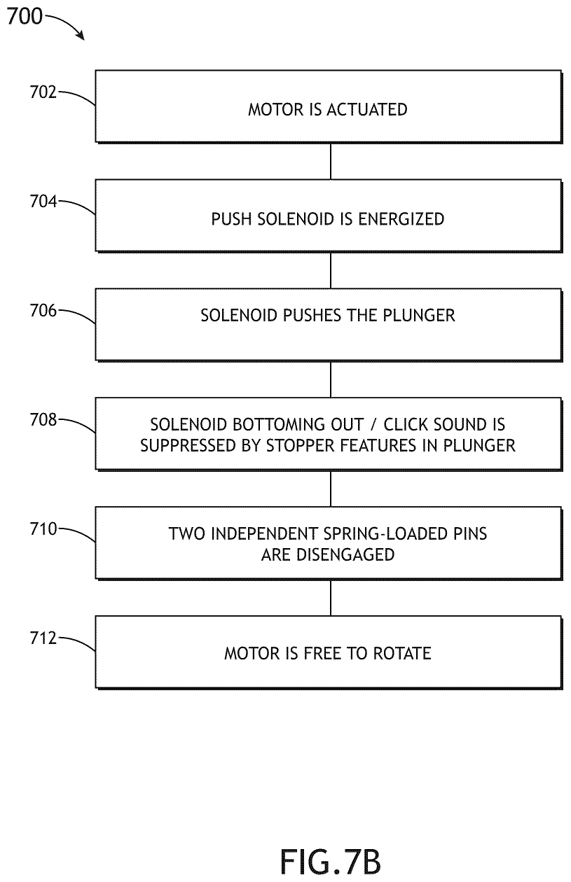

FIG. 7A illustrates the energized state of the solenoid 130 in which the solenoid shaft 132 is driven toward the spring-loaded plunger stop 138 to move the spring-loaded lock pins 150 out of contact with the locking ribs of the rotor gear 116, thereby allowing the rotor gear 116 to rotate by the rotational power transmitted from the electromechanical actuator assembly when the assembly is operating to rotate its shaft.

FIG. 7B illustrates the method 700 for energizing the solenoid 130 to free the electromechanical actuator assembly to rotate. In step 702, the motor is energized. In step 704 the push solenoid is energized. In step 706, the solenoid pushes the solenoid shaft (e.g., plunger). In step 708, the solenoid ‘bottoms out’, wherein any sound associated therewith may be suppressed by features in the solenoid shaft. In step 710, the two independent spring-loaded lock pins are disengaged from the locking ribs. In step 712, the motor is free to rotate to turn the at least one gearbox to rotate the shaft. One or more of the aforementioned steps may be performed simultaneously with at least one other step.

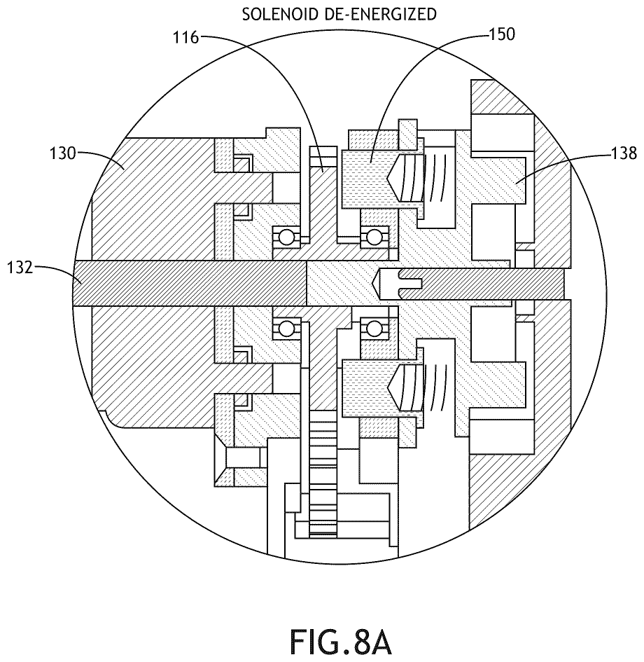

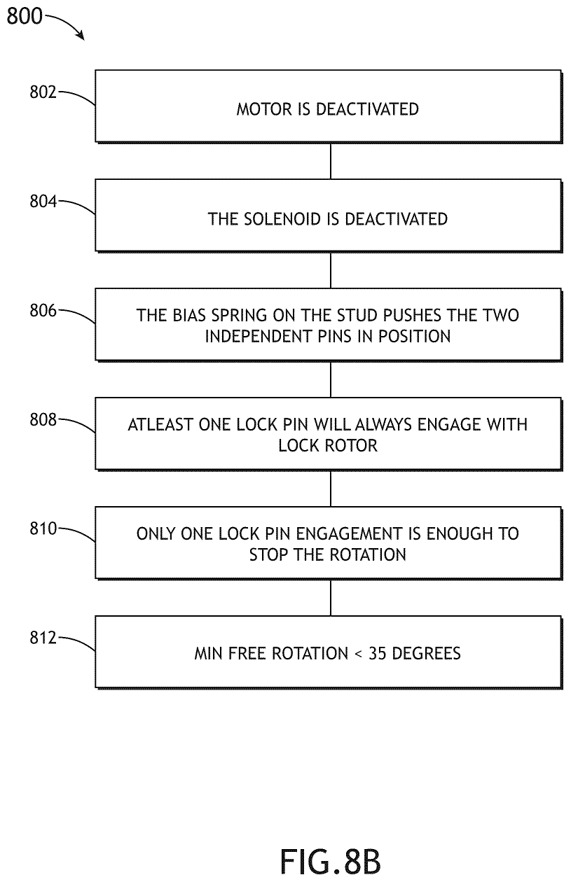

FIG. 8A illustrates the de-energized state of the solenoid 130 in which the spring force of the spring-loaded plunger stop 138 drives the solenoid shaft 132 into the solenoid 130 thereby moving the spring-loaded lock pins 150 into contact with the locking ribs of the rotor gear 116, thereby preventing the rotor gear 116 from rotating and consequently stopping the electromechanical actuator assembly from rotating.

FIG. 8B illustrates the method 800 for de-energizing the solenoid 130 to prevent the electromechanical actuator assembly from rotating. In step 802, the motor is de-energized. In step 804 the push solenoid is de-energized. In step 806, the spring force on the lock pins pushes the two independent spring-loaded lock pins into their locking positions. In step 808, at least one of the lock pins engages with one of the locking ribs. In step 810, rotor gear rotation is stopped. In step 812, any free rotation is less than 35 degrees in the three locking rib configuration disclosed herein. One or more of the aforementioned steps may be performed simultaneously with at least one other step.

From the above description, it is clear that the inventive concepts disclosed herein are well adapted to achieve the objectives and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. A lock mechanism for an electromechanical actuator assembly, comprising:
a housing mountable to an electromechanical actuator assembly;
a solenoid mounted to the housing, the solenoid including a reciprocating shaft;
a rotor gear mounted on the reciprocating shaft, the rotor gear including at least one locking rib positioned on one face of the rotor gear;
a spring-loaded plunger body coupled to one end of the reciprocating shaft; and
at least one spring-loaded lock pin carried by the plunger body;
wherein, in use:
when the solenoid is de-energized, spring force pushes the spring-loaded plunger body toward the rotor gear and spring force pushes the at least one spring-loaded lock pin into contact with the at least one locking rib to prevent rotation of the rotor gear; and
when the solenoid is energized, the reciprocating shaft pushes the spring-loaded plunger body away from the rotor gear thereby moving the at least one spring-loaded lock pin out of contact with the at least one locking rib to permit rotation of the rotor gear.

2. The lock mechanism according to claim 1, wherein:
the at least one locking rib comprises three equidistant and radially-extending locking ribs;
the at least one spring-loaded lock pin comprises two independent spring-loaded lock pins; and
when the solenoid is de-energized, the two independent spring-loaded lock pins contact two of the three equidistant and radially-extending locking ribs.

3. The lock mechanism according to claim 1, wherein the locking ribs extend in a direction of the plunger body.

4. The lock mechanism according to claim 1, further comprising a connector gear rotatably mounted to the housing and meshed with the rotor gear, the connector gear configured to mesh with a gear of the electromechanical actuator assembly.

5. The lock mechanism according to claim 1, wherein the at least one spring-loaded lock pin is slidably disposed in the plunger body.

6. The lock mechanism according to claim 1, wherein:
the plunger body comprises a first plate and a second plate spaced apart by a middle connecting portion; and
the at least one spring-loaded lock pin includes a shoulder movably disposed between the first plate and the second plate.

7. An actuator assembly, comprising:
an electromechanical actuator subassembly comprising:
a first housing;
a motor mounted to the first housing;
at least one gearbox mounted in the first housing; and
a shaft rotatably by the at least one gearbox; and
a lock mechanism comprising:
a second housing mounted to the first housing;
a solenoid mounted to the second housing, the solenoid including a reciprocating shaft;
a rotor gear mounted on the reciprocating shaft, the rotor gear including at least one locking rib positioned on one face of the rotor gear;
a connector gear meshed with the rotor gear and the at least one gearbox;
a spring-loaded plunger body coupled to one end of the reciprocating shaft; and
at least one spring-loaded lock pin carried by the plunger body;
wherein, in use:
when the solenoid is de-energized, spring force pushes the spring-loaded plunger body toward the rotor gear and spring force pushes the at least one spring-loaded lock pin into contact with the at least one locking rib to prevent rotation of the rotor gear thereby preventing the at least one gearbox and the shaft of the electromechanical actuator subassembly from rotating; and
when the solenoid is energized, the reciprocating shaft pushes the spring-loaded plunger body away from the rotor gear thereby moving the at least one spring-loaded lock pin out of contact with the at least one locking rib to permit rotation of the rotor gear thereby permitting the at least one gearbox and the shaft of the electromechanical actuator subassembly to rotate.

8. The actuator assembly according to claim 7, wherein:
the at least one locking rib comprises three equidistant and radially-extending locking ribs;
the at least one spring-loaded lock pin comprises two independent spring-loaded lock pins; and
when the solenoid is de-energized, the two independent spring-loaded lock pins contact two of the three equidistant and radially-extending locking ribs.

9. The actuator assembly according to claim 7, wherein the face of the rotor gear including the at least one locking rib faces the plunger body.

10. The actuator assembly according to claim 7, wherein the at least one spring-loaded lock pin is slidably disposed in the plunger body.

11. The actuator assembly according to claim 7, wherein the spring-loaded plunger is translatably disposed in the second housing.

12. The actuator assembly according to claim 7, wherein:
the plunger body comprises a first plate and a second plate spaced apart by a middle connecting portion; and
the at least one spring-loaded lock pin includes a shoulder movably disposed between the first plate and the second plate.

13. A method for controlling rotation of a shaft of an electromechanical actuator assembly, the method comprising:
providing a lock mechanism including:
a housing;
a solenoid mounted to the housing, the solenoid including a reciprocating shaft;
a rotor gear mounted on the reciprocating shaft, the rotor gear including at least one locking rib positioned on one face of the rotor gear;
a connector gear meshed with the rotor gear;
a spring-loaded plunger body coupled to one end of the reciprocating shaft; and
at least one spring-loaded lock pin carried by the plunger body;
mounting the lock mechanism to the electromechanical actuator assembly such that the connector gear is meshed with a gearbox for rotating the shaft;
de-energizing the solenoid such that spring force pushes the spring-loaded plunger body toward the rotor gear and spring force pushes the at least one spring-loaded lock pin into contact with the at least one locking rib to prevent rotation of the rotor gear and locking rotation of the shaft of the electromechanical actuator assembly; and
energizing the solenoid such that the reciprocating shaft pushes the spring-loaded plunger body away from the rotor gear thereby moving the at least one spring-loaded lock pin out of contact with the at least one locking rib to permit rotation of the rotor gear to unlock rotation of the shaft of the electromechanical actuator subassembly.

14. The method according to claim 13, wherein:
the at least one locking rib comprises three equidistant and radially-extending locking ribs;
the at least one spring-loaded lock pin comprises two independent spring-loaded lock pins; and
when the solenoid is de-energized, the two independent spring-loaded lock pins contact two of the three equidistant and radially-extending locking ribs.

15. The method according to claim 14, wherein the locking ribs protrude in a direction toward the spring-loaded plunger body.

16. The method according to claim 13, wherein the at least one spring-loaded lock pin is slidably disposed in the plunger body.

17. The method according to claim 13, wherein:
the plunger body comprises a first plate and a second plate spaced apart by a middle connecting portion; and
the at least one spring-loaded lock pin includes a shoulder movably disposed between the first plate and the second plate.
